(19) United States
(12) Patent Application Publication
(10) Pub. No.: US 2008/0257789 A1
(43) Pub. Date: Oct. 23, 2008

(54) Device for and Method of Separating Particles

(76) Inventor: Sergei Dimitrievich Vaulin, Randburg (ZA)

Correspondence Address: LAHIVE & COCKFIELD, LLP;FLOOR 30, SUITE 3000, ONE POST OFFICE SQUARE, BOSTON, MA, 02109, US

(21) Appl. No.: 11/658,122

(22) PCT Filed: Jul. 15, 2005
(86) PCT No.: PCT/IB2005/002026

§ 371 Date: Jul. 3, 2008

(30) Foreign Application Priority Data
Jul. 21, 2004 (ZA) 2004/5807

(51) Int. Cl. B07B 7/00

(52) U.S. Cl. 209/142; 209/606

(57) ABSTRACT

A device (32) is provided for separating particles in a material (34), the particles having different conductivities. The device (32) comprises a feeder (36) for accommodating the material (34), the feeder (36) defining an outlet opening (38). Charging means (40) is located within the feeder (36) and proximate the opening (38) of the feeder (36), the charging means (40) being arranged to directly charge the particles. The device (32) further includes a rotatable drum (42) that is located adjacent the opening (38) of the feeder (36). In use, the charging means (40) is arranged to produce a cloud of similarly charged particles that leave the feeder (36) via the opening (38) and land on the drum (42) substantially as a monolayer, with conductive particles (48) subsequently losing their charge to the drum (42) and thus falling off, while the insulative/less conductive particles (50) remain charged and thus attracted to the surface of the drum (42) so as to be removed further on in the rotation of the drum (42).

### BACKGROUND OF THE INVENTION

THIS invention relates to a device for and method of separating particles.

Referring to FIGS. 1 and 2, a conventional drum separator 10 is used for the separation of particles in a mixture 12, the particles having different conductivities. The mixture 12 of conductive particles 14 and insulative particles 16 is fed from a feeder or hopper 18 onto a rotatable drum 20. The drum 20 can have either a conductive or a non-conductive drum surface, but usually takes the form of a conductive drum surface, which will be assumed for the remainder of this specification. A layer of the mixture 12, ideally a monolayer, is placed at a top section of the rotating drum 20, which then moves the mixture 12 to a charging zone 22. In this zone all particles are equally charged by ions 24 produced by a corona electrode 26. Conductive particles 14 quickly lose their charge to the drum 20 and fall down from the surface 28 of the drum 20, primarily under the influence of gravity, and as indicated by arrows 30. Insulative particles 16, or at least less conductive particles, remain charged and thus remain attracted to the surface 28 of the drum 20 and are removed by electrical or mechanical means further on in the rotation of the drum 20.

A significant problem for achieving high grade and high throughput of separation is the feeding of the mixture 12. The type of separator 10 described above uses conductivity properties of the particles 14, 16 to create differences in charges, so as to differentiate the behavior of the particles 14, 16 in order to separate them. In this case, therefore, the positioning of the particles 14, 16 on the surface 28 of the drum 20 is an important factor. In particular, and as indicated above, the particles 14, 16 have ideally to form a monolayer on the surface 28 of the rotating drum 20 so as to achieve the best possible electrical contact between all of the particles 14, 16 and the surface 28 of the drum 20. However, this is often not possible, with excess particles 14, 16 often being fed so as to form more than one layer on the drum surface 28, as shown in FIG. 3. This tends to severely degrade the quality of separation.

Several measures are used to address the problem mentioned above, including, for example, decreasing the feed rate. However, one of the major difficulties with the separation of particles, and in particular, fine particles, is agglomeration. Agglomeration can be caused by a number of different factors, one of them being the presence of electrostatic charges. Electrostatic charges result from past processes with the particles, and from triboelectricification processes. These charges and resulting forces start to play a bigger and bigger role with decreasing particle size. The surface and mass of the particles are, respectively, the second and third order of the physical dimensions. Thus, for the same density of surface charges, the relatively smaller particle size results in the electrostatic forces becoming larger than the force of gravity, so that particles with different charges stay attracted to each other. Such agglomerates are very stable and can hold charges for very long periods of time.

Conventional separation processes of the type described above can not be performed under such conditions as these agglomerates are formed from different types of particles. It is therefore an object of the present invention to eliminate or reduce the formation of such agglomerates and to create conditions that prevent the formation of such agglomerates, thereby allowing the separation of these materials.

### SUMMARY OF THE INVENTION

According to a first aspect of the present invention there is provided a device for separating particles in a material, the particles having different conductivities, the device comprising:
a feeder for accommodating the material, the feeder defining an outlet opening;
charging means located within the feeder and proximate the outlet opening of the feeder, the charging means being arranged to directly charge the particles; and
a rotatable transfer means located adjacent the outlet opening of the feeder,
   wherein the charging means is arranged to produce a cloud of similarly charged particles that leave the feeder via the outlet opening and land on the rotatable transfer means substantially as a monolayer, with conductive particles subsequently losing their charge to the transfer means and thus falling off the surface of the transfer means, while the insulative/less conductive particles remain charged and thus attracted to the surface of the transfer means so as to be removed by electrical or mechanical means further on in the rotation of the transfer means.

Preferably, the charging means comprises at least one corona electrode for producing a conductive plasma around the at least one corona electrode, the plasma in turn causing the cloud of similarly charged particles to leave the feeder.

Typically, to produce the conductive plasma around the electrode, a voltage of between 10-50 kV is applied to an electrode having a diameter of less than 1 mm.

Alternatively, the charging means can take the form of a plurality of stacked metal plates that are kept at a high voltage, with the particles being arranged to slide past the plates in order to charge the particles.

Conveniently, to assist in the separation of the particles in the material, a vibrator is fitted adjacent the feeder for vibrating the feeder.

According to a second aspect of the present invention there is provided a method of separating particles in a material, the particles having different conductivities, the method comprising the steps of:
providing a feeder for accommodating the material, the feeder defining an outlet opening;
charging the particles prior to the particles leaving the feeder via the outlet opening, so as to produce a cloud of similarly charged particles; and
providing a rotatable transfer means located adjacent the outlet opening of the feeder,
   wherein the charged particles land on the transfer means substantially as a monolayer, with conductive particles subsequently losing their charge to the transfer means and thus falling off the surface of the drum, while the insulative/less conductive particles remain charged and thus attracted to the surface of the transfer means so as to be removed by electrical or mechanical means further on in the rotation of the transfer means.

Conveniently, the method includes the step of vibrating the feeder.

### BRIEF DESCRIPTION OF THE DRAWINGS

FIG. 1 shows a conventional drum separator for separating particles having different conductivities;

FIG. 2 shows a side view of a section of the drum of the conventional drum separator shown in FIG. 1;

FIG. 3 shows the problem that the present invention aims to address, namely the agglomeration of particles, and in particle fine particles, on the surface of the drum of the conventional drum separator;

FIG. 4 shows a drum separator for separating particles having different conductivities according to the present invention;

FIG. 5 shows an outlet opening of a feeder used in the drum separator shown in FIG. 4, illustrating a cloud of similarly charged particles leaving the feeder via the outlet opening, the cloud being produced by a plurality of corona electrodes;

FIG. 6 shows the electric field structure produced by one of the plurality of electrodes used in the present invention; and

FIG. 7 shows the particles landing on a drum of the drum separator of the present invention so as to define a monolayer of particles on the drum.

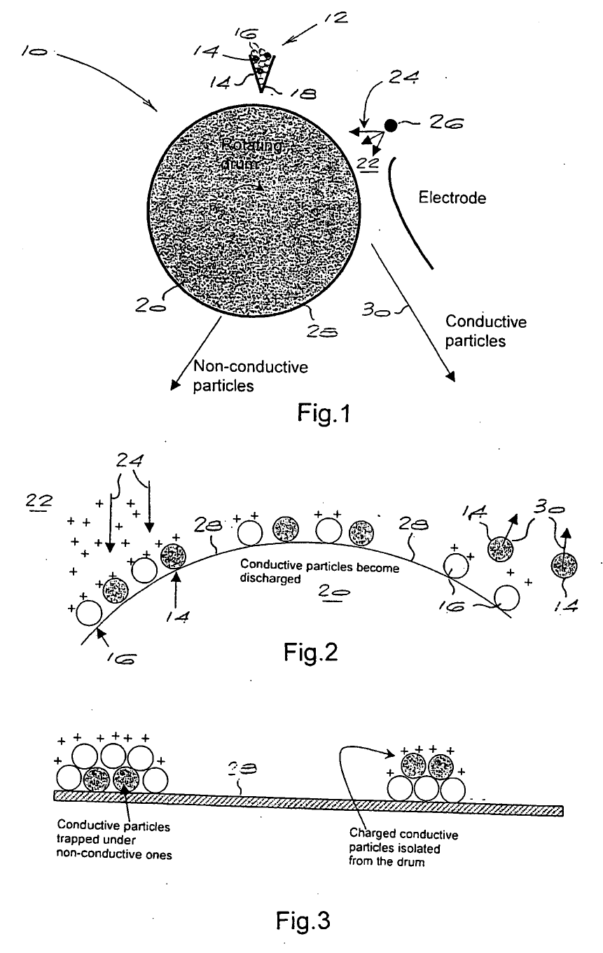

### DESCRIPTION OF PREFERRED EMBODIMENTS

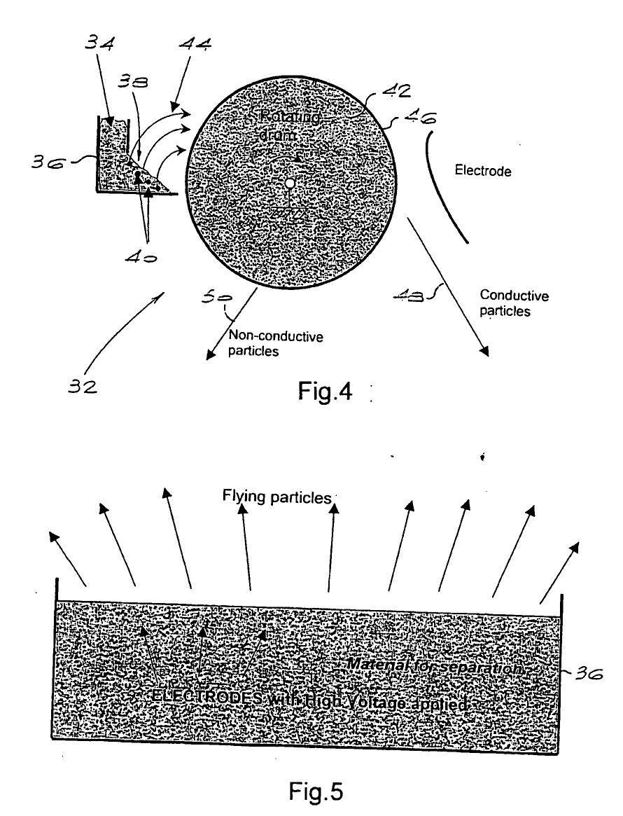

Referring to FIG. 4, a device 32 is shown for separating particles in a material 34, the particles having different conductivities. The device 32 comprises a feeder 36 for accommodating the material 34, the feeder 36 defining an outlet opening 38. Charging means, in the form of at least one corona electrode 40, is located proximate the outlet opening 38 of the feeder 36. Significantly, the charging means is submerged in the material 34 so as to directly charge the particles.

A rotatable drum 42 is located adjacent the outlet opening of the feeder.

In use, the charging means 40 produces a cloud of similarly charged particles that leave the feeder 36 via the outlet opening 38, as indicated by arrow 44. The particles land on the rotatable drum 42 as a monolayer, with conductive particles subsequently losing their charge to the transfer means 42 and thus falling off the surface 46 of the drum, as indicated by arrow 48. The insulative/less conductive particles remain charged and thus attracted to the surface 46 of the drum 42 so as to be removed by electrical or mechanical means further on in the rotation of the drum 42, as indicated by arrow 50.

Thus, the crux of the present invention is to charge all particles to the same potential charge density prior to them landing on the rotating drum 42, in order to destroy attractive forces of the particles, thereby preventing the formation of agglomerates. This could not be done with the existing drum separators by simply applying free charges to the agglomerates, as these charges would reside at their surface and would increase the attractive forces between the particles.

A grid of such corona electrodes can be used to increase the total volume of plasma and volume of material residing simultaneously in this area. All particles of the material will achieve the same charge density and attracting forces will be eliminated and replaced with repelling ones. This will break the agglomerates and single particles will fly away one from another. This disagglomeration is shown in FIG. 5. To further assist in the prevention of the formation of agglomerates, a vibrator can be fitted adjacent the feeder. This vibrator would serve to not only level the particles within the feeder, but to also prevent a rigid or blocking top layer from forming within the feeder, thereby facilitating the feeding process.

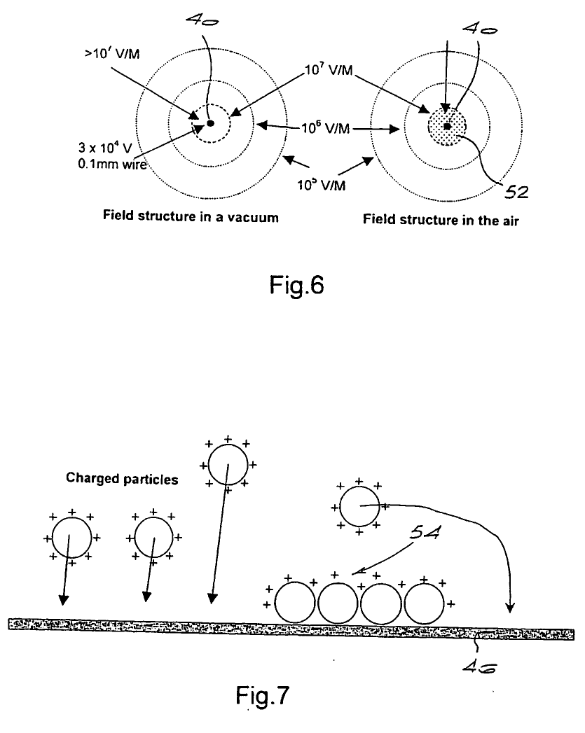

Typically, to produce the conductive plasma around the electrode 40, a voltage of between 10-50 kV is applied to an electrode having a diameter of less than 1 mm. This will create a high intensity electrical field around the electrode 40 due to its small radius, and as this field strength is not greater than field strength for air breakdown, this will initiate discharge and create a conductive zone around the electrode 40. The diameter of this conductive zone will depend on the voltage applied and will increase as the voltage increases. The formation of the conductive zone 52 is shown in more detail in FIG. 6, and it is in this zone that direct charging of the particles of the material 34 will take place.

As indicated above, a cloud of evenly charged particles will be generated by the charging device 40. These particles will be attracted to any object that has a different potential. Due to the charges residing on these particles, they will form a monolayer 54 at this surface, as shown in FIG. 7. The formation of the monolayer, as described above, is ideal and thus the present invention is particularly well suited for separating fine particles that are more prone to agglomeration.

In an alternative version of the invention, it is envisaged that the particles within the material could be charged by causing them to slide past, or otherwise causing them to contact, metal parts that are kept at high voltage. It is believed that this arrangement would be particularly useful in applications that require a reasonably high feed rate. In particular, it is envisaged that a stack of copper plates, at high voltage, through which the material flows could be used to achieve this.

1. A device for separating particles in a material, the particles having different conductivities, the device comprising:
a feeder for accommodating the material, the feeder defining an outlet opening;
charging means located within the feeder and proximate the outlet opening of the feeder, the charging means being arranged to directly charge the particles to substantially the same charge, the charging means comprising at least one corona electrode for producing a conductive plasma around the at least one corona electrode; and
a rotatable transfer means located adjacent the outlet opening of the feeder.
Wherein the charging means is arranged to produce a cloud of similarly charged particles that leave the feeder via the outlet opening and land on the rotatable transfer means substantially as a monolayer, with conductive particles subsequently losing their charge to the transfer means and thus falling off the surface of the transfer means, while the insulative/less conductive particles remain charged and thus attracted to the surface of the transfer means so as to be removed by electrical or mechanical means further on in the rotation of the transfer means.

2. A device for separating particles in a material according to claim 1, wherein to produce the conductive plasma around the electrode, a voltage of between 10-50 kV is applied to an electrode having a diameter of less than 1 mm.

3. A device for separating particles in a material according to claim 1, wherein the charging means comprises a plurality of stacked metal plates that are kept at a high voltage, with the particles being arranged to slide past the plates in order to charge the particles.

4. A device for separating particles in a material according to claim 1, wherein to assist in the separation of the particles in the material, a vibrator is fitted adjacent the feeder for vibrating the feeder.

5. A method of separating particles in a material, the particles having different conductivities, the method of comprising the steps of:
providing a feeder for accommodating the material, the feeder defining an outlet opening;
providing at least one corona electrode to produce a conductive plasma around the at least one corona electrode for directly charging the particles to substantially the same charge prior to the particles leaving the feeder via the outlet opening, so as to produce a cloud of similarly charged particles; and
providing a rotatable transfer means located adjacent the outlet opening of the feeder,
wherein the charged particles land on the transfer means substantially as a monolayer, with conductive particles subsequently losing their charge to the transfer means and thus falling off the surface of the drum, while the insulative/less conductive particles remain charged and thus attracted to the surface of the transfer means so as to be removed by electrical or mechanical means further on in the rotation of the transfer means.

6. A method of separating particles in a material according to claim 5, wherein the method includes the step of vibrating the feeder.
